(19) United States
(12) Patent Application Publication
(10) Pub. No.: US 2025/0141115 A1
(43) Pub. Date: May 1, 2025

(54) ANTENNA

(71) Applicant: AGC Inc., Tokyo (JP)

(72) Inventors: Yang HAO, London (GB); Henry GIDDENS, London (GB); Osamu KAGAYA, Chiyoda-ku (JP); Shimpei TOMIDA, Chiyoda-ku (JP)

(73) Assignee: AGC Inc., Tokyo (JP)

(21) Appl. No.: 19/004,932

(22) Filed: Dec. 30, 2024

Related U.S. Application Data
(63) Continuation of application No. PCT/JP2023/023924, filed on Jun. 28, 2023.

(30) Foreign Application Priority Data
Jul. 4, 2022 (JP) 2022-108053

(51) Int. Cl. H01Q 19/06; H01Q 1/32

(52) U.S. Cl. CPC H01Q 19/06; H01Q 1/32

(57) ABSTRACT

An object is to provide a small directional antenna. A radio wave deflection element is formed as a plate-like member including a plurality of stacked dielectric layers, having a principal surface perpendicular to a first direction, and having a longitudinal direction in a second direction perpendicular to the first direction; and a radio wave source is disposed so as to be separated from the radio wave deflection element in the first direction and offset from a center of the radio wave deflection element by a predetermined distance in the first direction, and configured to emit a radio wave to the radio wave deflection element. Dielectric constants of the plurality of dielectric layers decrease in a stepwise manner as a distance from the center of the radio wave deflection element increases in the first direction.

### INCORPORATION BY REFERENCE

This application is based upon and claims the benefit of priority from Japanese patent application No. 2022-108053, filed on Jul. 4, 2022, and PCT application No. PCT/JP2023/023924 filed on Jun. 28, 2023, the disclosure of which is incorporated herein in its entirety by reference.

### BACKGROUND

The present disclosure relates to an antenna.

In recent years, radio communication has been widely performed between a vehicle such as an automotive and a communication apparatus installed in an arbitrary outdoor facility. In vehicles, microwaves or millimeter waves are used to transmit/receive radio waves to/from the outside. However, it is expected that as communication speeds increase in the future, such communication will be performed at higher frequencies, for example, in a high frequency band higher than 10 GHz.

In such a high frequency band, radio waves may be attenuated in a window glass, so a method for suppressing the attenuation of radio waves in a window glass has been proposed (International Patent Publication No. WO2020/105670).

### SUMMARY

However, in order to perform radio communication using radio waves having relatively high frequencies between a vehicle such as an automotive and a fixed communication apparatus, it is desirable to emit a highly directional radio wave to the place where the communication apparatus is installed. However, in general, an antenna provided in a vehicle is an omni-directional antenna.

Further, an ordinary directional antenna has a more complicated structure and a larger size than the structure and the size of an omni-directional antenna. Therefore, in order to mount such a directional antenna in a vehicle, it is desired that the directional antenna have a small size and a shape suitable for being mounted in the vehicle.

An antenna according to an embodiment includes: a radio wave deflection element formed as a plate-like member including a plurality of stacked dielectric layers, having a principal surface perpendicular to a first direction, and having a longitudinal direction in a second direction perpendicular to the first direction; and a radio wave source disposed so as to be separated from the radio wave deflection element in the first direction and offset from a center of the radio wave deflection element by a predetermined distance in the first direction, and configured to emit a radio wave to the radio wave deflection element, in which dielectric constants of the plurality of dielectric layers decrease in a stepwise manner as a distance from the center of the radio wave deflection element increases in the first direction.

According to an embodiment, it is possible to provide a small directional antenna.

The above and other objects, features and advantages of the present disclosure will become more fully understood from the detailed description given hereinbelow and the accompanying drawings.

### BRIEF DESCRIPTION OF DRAWINGS

FIG. 1 is a lateral view schematically showing a relationship between an antenna mounted on a vehicle and a base station;

FIG. 2 schematically shows an appearance of an antenna according to a first embodiment;

FIG. 3 schematically shows a cross section of a windshield and an antenna when a vehicle is viewed from the side;

FIG. 4 schematically shows a cross-sectional configuration in the z-x plane of the antenna according to the first embodiment;

FIG. 5 is a perspective view of a radio wave deflection element according to the first embodiment;

FIG. 6 is a cross-sectional view in the z-x plane of the radio wave deflection element according to the first embodiment;

FIG. 7 schematically shows radii, thicknesses, and dielectric constants of dielectric layers according to the first embodiment;

FIG. 8 schematically shows a position at which a radio wave source is installed;

FIG. 9 shows emission patterns of radio waves when the offset of the radio wave source is set to 0 mm;

FIG. 10 shows emission patterns of radio waves when the offset of the radio wave source is set to −7.5 mm;

FIG. 11 shows emission patterns of radio waves when the offset of the radio wave source is set to −15 mm;

FIG. 12 shows a difference between an emission pattern of a radio wave when a cavity cover is provided and that when no cavity cover is provided;

FIG. 13 shows emission patterns of V-polarized waves when the antenna is bonded to a windshield;

FIG. 14 shows emission patterns of H-polarized waves when the antenna is bonded to a windshield;

FIG. 15 shows deflection angles, gains, and beam widths of the V-polarized waves shown in FIG. 13 and those of the H-polarized waves shown in FIG. 14;

FIG. 16 shows emission patterns of V-polarized waves and H-polarized waves when the antenna is bonded to a windshield;

FIG. 17 shows emission patterns of V-polarized waves and H-polarized waves when the antenna is bonded to a rear glass;

FIG. 18 is a cross-sectional diagram in the z-x plane of an antenna according to a second embodiment;

FIG. 19 shows a difference between an emission pattern when a prism is provided and that when no prism is provided;

FIG. 20 is a graph showing a relationship between the z-coordinate in the axial direction of an ideal spherical Luneburg lens represented by Expression [1] and a value ε·δ, i.e., a value obtained by multiplying a compressibility δ in the z-direction of the lens by a dielectric constant & thereof;

FIG. 21 is a flowchart of a procedure for determining dielectric constants and thicknesses of a plurality of dielectric layers constituting a radio wave deflection element;

FIG. 22 shows an overview of a design of dielectric constants and thicknesses of dielectric layers when the number of layers is six;

FIG. 23 shows dielectric constants and thicknesses in the z-direction of the dielectric layers obtained from the curve shown in the graph shown in FIG. 22;

FIG. 24 shows an example of dielectric constants and thicknesses of dielectric layers when the number of layers is five;

FIG. 25 shows an example of dielectric constants and thicknesses of dielectric layers when the number of layers is four;

FIG. 26 shows an example of dielectric constants and thicknesses of dielectric layers when the number of layers is three;

FIG. 27 shows a relationship between the x-coordinate of a planar Luneburg lens and the dielectric constant Ex thereof;

FIG. 28 shows an overview of a design of dielectric constants and widths in the x-direction of dielectric layers when the number of dielectric layers is six;

FIG. 29 shows dielectric constants and widths in the x-direction of the dielectric layers L1 to L6 obtained from the curve shown in the graph shown in FIG. 28; and

FIG. 30 schematically shows a cross-sectional configuration of a radio wave source formed as a waveguide.

### DESCRIPTION OF EMBODIMENTS

### First Embodiment

An antenna 100 according to a first embodiment will be described. The antenna 100 is formed as a box-shaped directional antenna that deflects a radio wave emitted from a radio wave source at a desired angle by a radio wave deflection element, and emits the deflected radio wave. The antenna 100 is formed as, for example, a small antenna that can be mounted inside a cabin, installed in a vehicle. Specifically, the antenna 100 is mounted on the inner surface of one or each of a windshield and a rear glass of a vehicle.

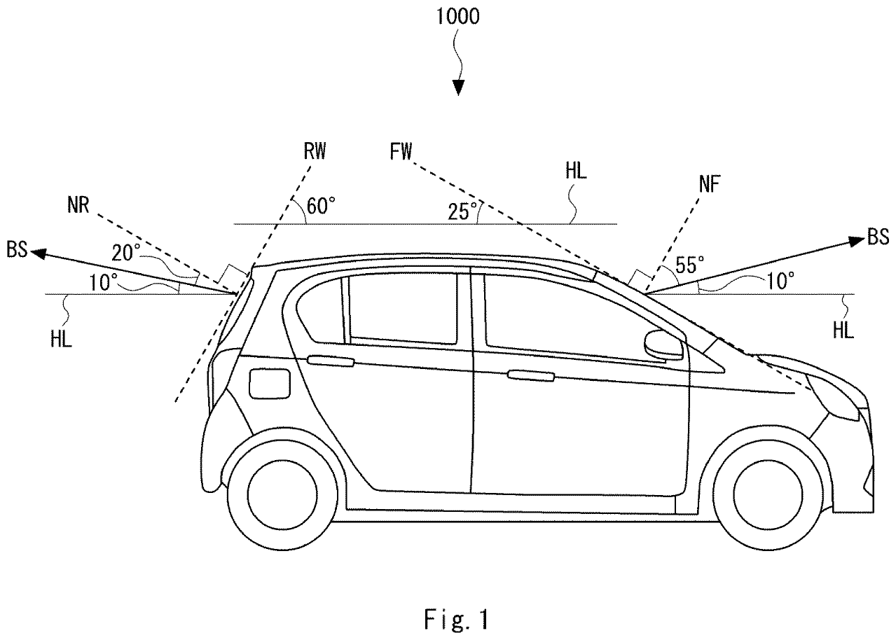

FIG. 1 is a lateral view schematically showing a relationship between an antenna mounted in a vehicle 1000 and a base station BS.

In this example, an angle between a line FW indicating the surface of the windshield of the vehicle 1000 (e.g., a plane perpendicular to a normal NF passing through the center of the windshield) and a horizontal plane HL, i.e., the inclination angle of the windshield, is 25°, and an angle between a line RW indicating the surface of the rear glass (e.g., a plane perpendicular to a normal NR passing through the center of the rear glass) and the horizontal plane HL, i.e., the inclination angle of the rear glass, is 60°. It is conceivable that the base station BS, in which a communication apparatus for exchanging radio waves with the vehicle is mounted, is installed, for example, on the top of a roadside building. Taking such a situation into consideration, it is conceivable that the elevation angle when the base station BS is viewed from the vehicle 1000 is about 10° relative to the horizontal plane HL. Note that the surfaces of the windshield and the rear glass are often gently curved. However, for the sake of simplifying the following explanation, it is assumed that they are flat.

In this embodiment, the antenna 100 is attached to the inner surface of a windshield or a rear glass, and transmits/receives radio waves. Therefore, for example, when the base station BS is viewed from the antenna 100 bonded to the glass surface, the angle between the normal NF of the surface of the windshield and the horizontal plane HL is 55° in the direction of the depression angle. Further, the angle between the normal NR of the surface of the rear glass and the horizontal plane HL is 20° in the direction of the depression angle. Therefore, when the antenna 100 is installed on the windshield, it is required to emit a radio wave while deflecting the emitted radio wave by about 55°, whereas when it is installed on the rear glass, it is required to emit a radio wave while deflecting the emitted radio wave by about 20°.

The antenna 100 described hereinafter emits a radio wave in a 28 GHz band. Note that the following description will be given on the assumption that radio waves in the 28 GHz band are radio waves in a band of 27.5 MHz to 29.5 GHZ (i.e., 28.5 GHz±1.0 MHz). However, radio waves emitted from the antenna 100 are not limited to the 28 GHz band, and the antenna 100 may emit a radio wave in an arbitrary band according to the use.

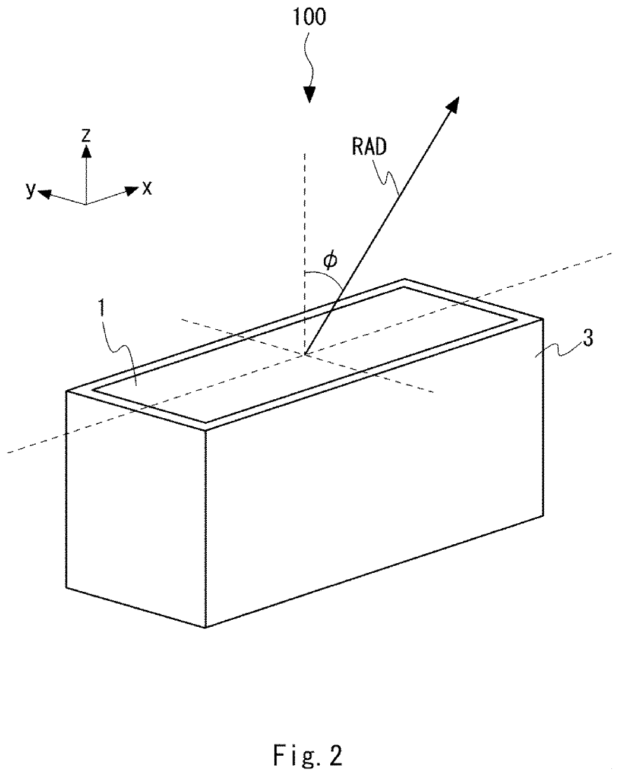

FIG. 2 shows an external appearance of the antenna 100 according to the first embodiment. The antenna 100 has such a configuration that a radio wave deflection element 1 is provided on its upper surface, and the side surfaces and the bottom surface of the radio wave deflection element 1 are covered by a cavity cover 3 made of conductive material and including an opening formed on the upper part. In FIG. 2, the principal surface of the radio wave deflection element 1 is a surface parallel to the x-y plane, and the normal direction of the principal surface is parallel to the z-direction. Further, the radio wave deflection element 1 has a shape that is relatively long in the x-direction and short in the y-direction in the x-y plan view (i.e., when viewed along the z-axis). Further, the shape of the cavity cover 3 in the x-y plan view is similar to that of the radio wave deflection element 1, and the cavity cover 3 has a shape extending from the radio wave deflection element 1 in the −z-direction. The antenna 100 is configured to emit a radio wave obliquely upward. In FIG. 2, the antenna 100 is configured to emit a radio wave in a direction deflected from the +z-direction toward the +x-direction by a deflection angle φ.

In the following description, the z-direction is also referred to as a first direction; the x-direction is also referred to as a second direction; and the y-direction is also referred to as a third direction.

It is assumed that the emitted radio wave includes a V-polarized wave or an H-polarized wave. In an embodiment, a polarized wave having a wave surface in a direction vertical to the emitting direction, i.e., a polarized wave parallel to the z-x plane, is referred to as a V-polarized wave, and a polarized wave having a wave surface in a direction horizontal to the emitting direction is referred to as an H-polarized wave. Note that in the following description, it is assumed that the radio wave is a V-polarized wave unless otherwise specified.

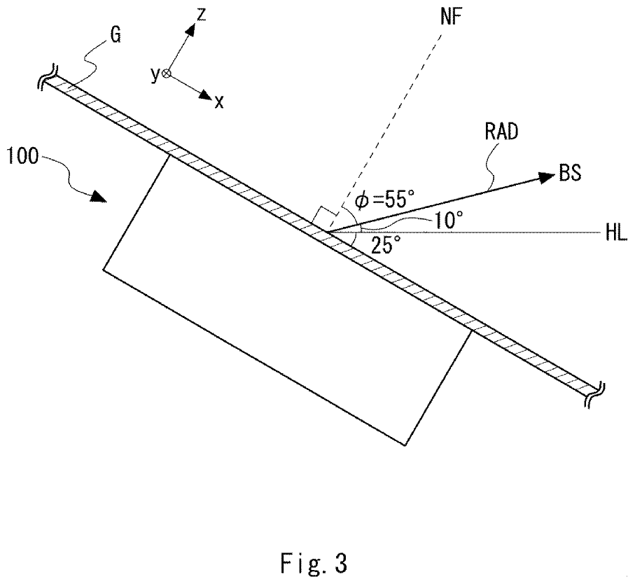

The antenna 100 is bonded to the inner surface of a windshield or a rear glass of a vehicle, and is attached to the glass surface in such a manner that the longitudinal direction (x-direction) is roughly parallel to the up/down direction of the windshield or the rear glass. An example in which an antenna is attached to the inner surface of a windshield will be described hereinafter. FIG. 3 schematically shows a cross section of the windshield and the antenna 100 when the vehicle is viewed from the side. In this case, the antenna 100 is bonded to the inner surface of the windshield G such that the x-direction, which is the longitudinal direction, is parallel to the up/down direction of the windshield G, and the y-direction is parallel to the horizontal direction of the windshield G (the normal direction of the paper in FIG. 3). As a result, the principal surface (x-y plane) of the radio wave deflection element 1 of the antenna 100 faces in the direction of the normal NF of the windshield G. In this case, the antenna 100 is configured so that the deflection angle o of a radio wave RAD emitted from the radio wave deflection element 1 is about 55°, so that the radio wave RAD is emitted toward the base station BS.

Note that although it is not shown, in the case where the antenna 100 is bonded to the inner surface of a rear glass, the antenna 100 is configured so that the deflection angle o of the radio wave RAD emitted from the radio wave deflection element 1 is about 20° and hence the radio wave RAD is emitted toward the base station BS.

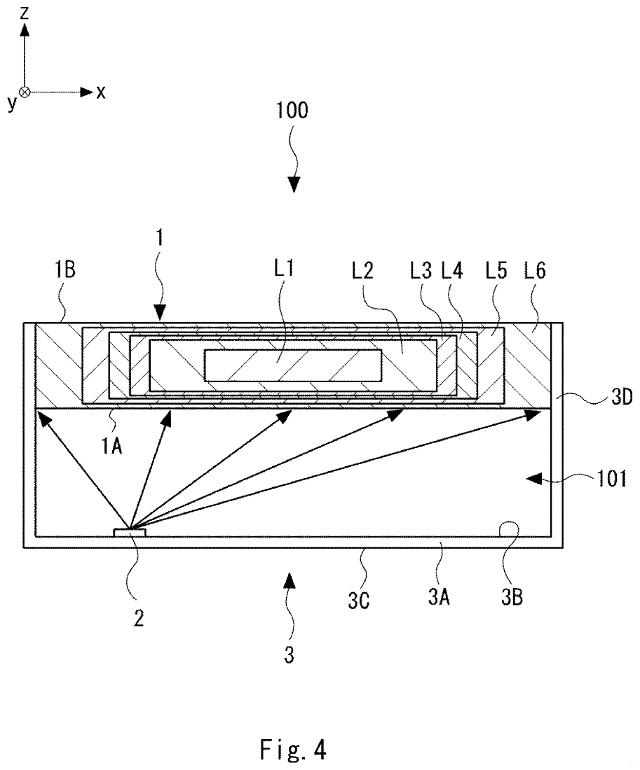

Next, the configuration of the antenna 100 will be described in a more detailed manner. FIG. 4 shows a cross-sectional configuration in the z-x plane of the antenna 100 according to the first embodiment. The antenna 100 includes a radio wave deflection element 1, a radio wave source 2, and a cavity cover 3. The radio wave deflection element 1 is formed as an element made of a material capable of letting a radio wave pass therethrough and having a planar Luneburg lens structure. Note that the principle, the configuration, and the manufacturing method of an ordinary planar Luneburg lens are described in Non-patent Literatures 1 and 2.

In the radio wave deflection element 1, a radio wave is incident on an incident plane 1A of which the normal direction is parallel to the z-axis direction, and a deflected radio wave is emitted from an exit plane 1B of which the normal direction is parallel to the z-axis direction. The thickness of the radio wave deflection element I in the z-axis direction between the incident plane 1A and the exit plane 1B is represented by T. In this example, T is 7 mm (T=7 mm).

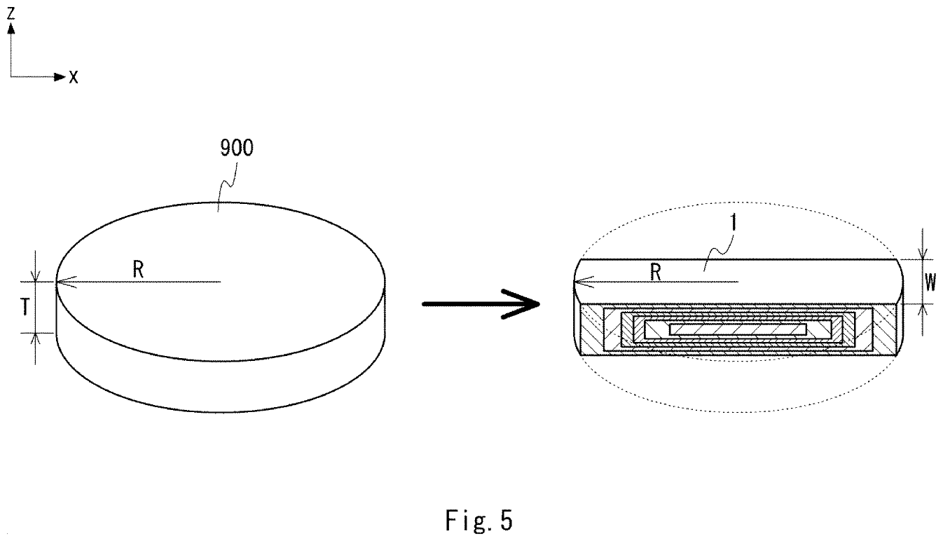

The radio wave deflection element 1 is a member-the longitudinal direction of which is parallel to the x-axis direction, and has a shape that is obtained by cutting out a part of a disk-like planar Luneburg lens, for example, disclosed in C. Mateo-Segura, A. Dyke, H. Dyke, S. Haq, and Y. Hao, “Flat Luneburg Lens via Transformation Optics for Directive Antenna Applications,” IEEE Transactions on Antennas and Propagation, vol. 62, no. 4, pp. 1945-1953 April 2014 (Hereinafter, it is referred to as Non-patent Literature 1), or R. Foster, D. Nagarkoti, J. Gao, B. Vial, F. Nicholls, C. Spooner, S. Haq, and Y. Hao, “Beam-Steering Performance of Flat Luneburg Lens at 60 GHz for Future Wireless Communications,” International Journal of Antennas and Propagation, Volume 2017, Article ID 7932434, 8 pages, [Online], Retrieved on Apr. 28, 2022, <URL>https://www.hindawi.com/journals/ijap/2017/7932434/ (Hereinafter, it is referred to as Non-patent Literature 2) of which the principal surface is parallel to the x-y plane in the x-y plan view (i.e., of which the axial direction is parallel to the z-axis direction). FIG. 5 is a perspective view of the radio wave deflection element 1 according to the first embodiment. When the width of the radio wave deflection element 1 in the y-direction is represented by W, the radio wave deflection element 1 has a shape that is obtained by cutting out an area of a planar Luneburg lens 900 having a radius R, between a plane separated from the z-x plane by a distance −w/2 along the y-axis and a plane separated from the z-x plane by a distance w/2 along the y-axis. Therefore, the diameter 2R of the disk becomes the length of the radio wave deflection element 1 in the x-direction. In this embodiment, the length of the radio wave deflection element 1 in the x-direction is 42 mm (the radius R is 21 mm), and the width W thereof is 10 mm.

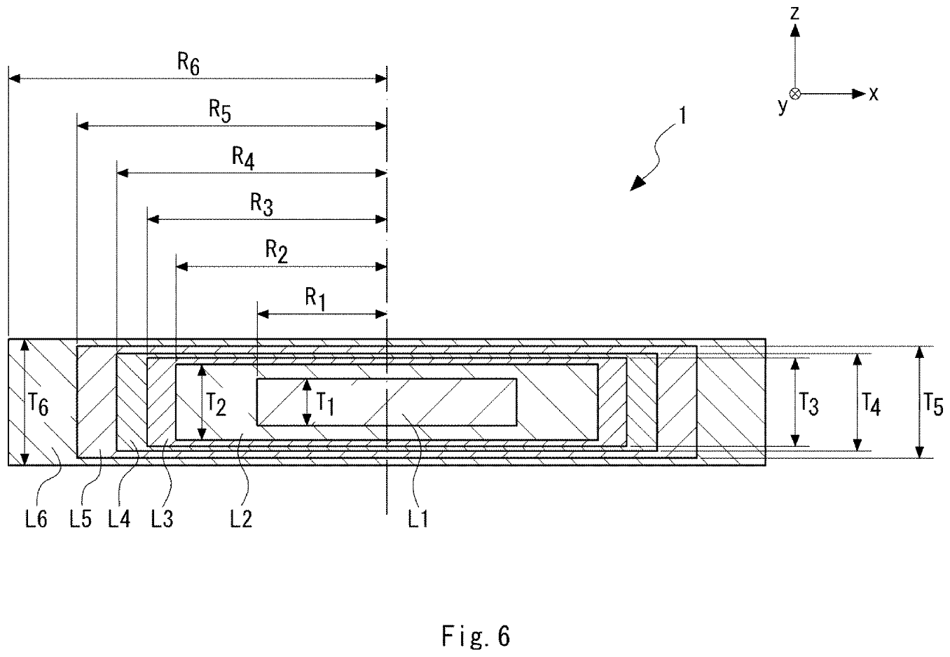

The radio wave deflection element 1 has a multilayer structure made of dielectric materials, and the dielectric constants of the layers are different from one another. FIG. 6 is a cross-sectional view in the z-x plane of the radio wave deflection element 1 according to the first embodiment. The radio wave deflection element 1 is composed of six dielectric layers L1 to L6 which form a nested structure from the center toward the outer edge. The dielectric layer L1 of which the longitudinal direction is parallel to the x-direction is provided at the center, and the dielectric layers L2 to L6 are formed one after another in the nested structure from the dielectric layer L1 toward the outer edge of the radio wave deflection element 1.

The dielectric constants of the dielectric layers L1 to L6 decrease in a stepwise manner from the dielectric layer L1 to the dielectric layer L6. As the material of the dielectric layers L1 to L6, various resins such as an ABS (acrylonitrile butadiene styrene) resin can be used. In the following description, the radii of the dielectric layers L1 to L6 are represented by R₁ to R₆, respectively, and the thicknesses thereof are represented by T₁ to T₆, respectively. Further, their dielectric constants are represented by ε₁ to ε₆, respectively.

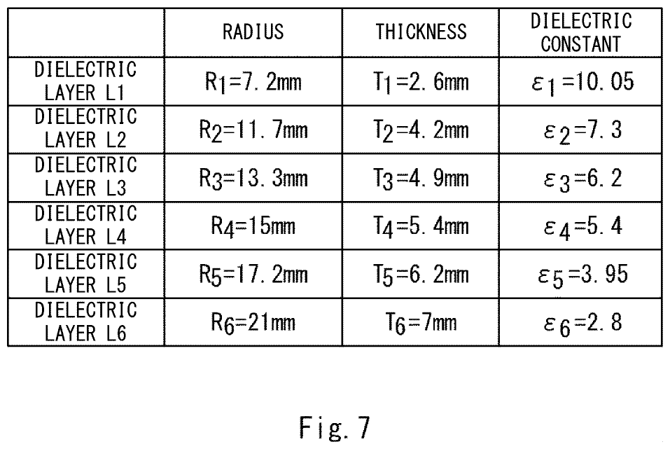

FIG. 7 shows the radii, thicknesses, and dielectric constants of the dielectric layers L1 to L6 according to the first embodiment. As shown in FIG. 7, the dielectric layer L1 has the highest dielectric constant, and the dielectric constants decrease in a stepwise manner from the dielectric layer L1 to the dielectric layer L6. By adopting the multilayer structure described above, the radio wave deflection element 1 functions as a planar Luneburg lens of which the central axis (i.e., the optical axis in the optical lens) is, for radio waves, parallel to the z-axis and of which the width is regulated to W.

The configuration of the antenna 100 will be further described. As shown in FIG. 4, the cavity cover 3 is composed of side plates 3D which are members covering the side surfaces of the radio wave deflection element 1, and a bottom plate member 3A which is separated from the radio wave deflection element 1 in the −z-direction and of which the principal surface is parallel to the x-y plane. The radio wave source 2 is provided on an upper surface 3B (i.e., a surface on the +z side) of the bottom plate member 3A. In this example, the radio wave source 2 is formed as a patch antenna and is supplied with electricity through feeding means (not shown), such as a connector, provided on a lower surface 3C (i.e., a surface on the −z side) of the bottom plate member.

Note that the space surrounded by the radio wave deflection element 1 and the cavity cover 3 is hereinafter referred to as a cavity 101. Further, the length of the cavity 101 in the z-direction is represented by H [mm]. In this example, H is 11 [mm] (H=11 [mm]).

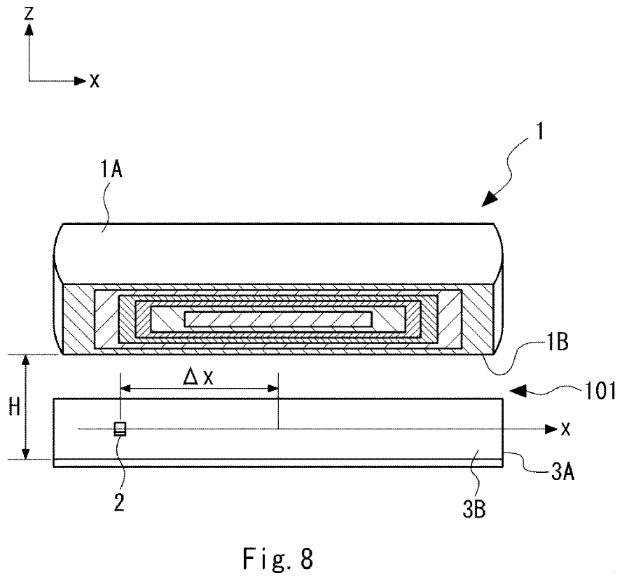

FIG. 8 schematically shows a position at which the radio wave source 2 is installed. The radio wave source 2 is formed as a patch antenna of which, for example, the principal surface is parallel to the x-y plane, and is disposed at a position offset from the center line on the z-x cross section of the antenna 100 in the −x-direction by a distance Δx. As a result, a radio wave is emitted from the radio wave source 2, which is disposed at the position offset from the central axis of the radio wave deflection element 1 by the distance −Δx, so that a radio wave emitted from the radio wave deflection element 1 is also deflected in a direction inclined from the z-axis toward the x-axis by a deflection angle 100 .

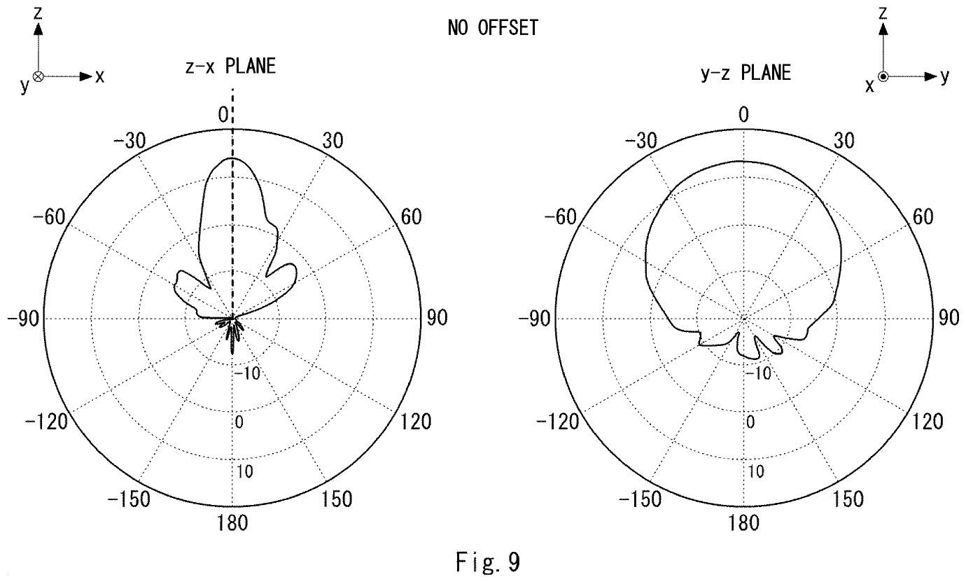

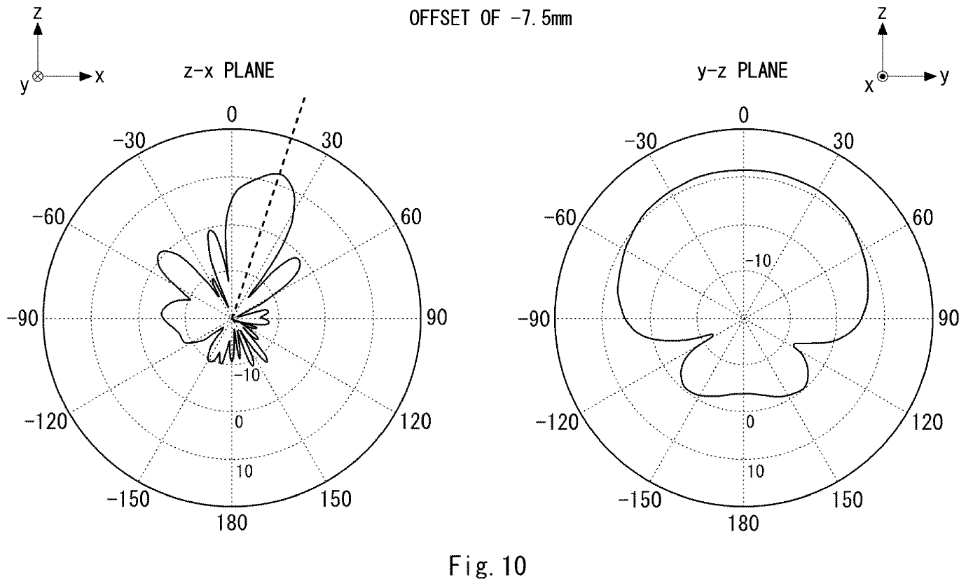

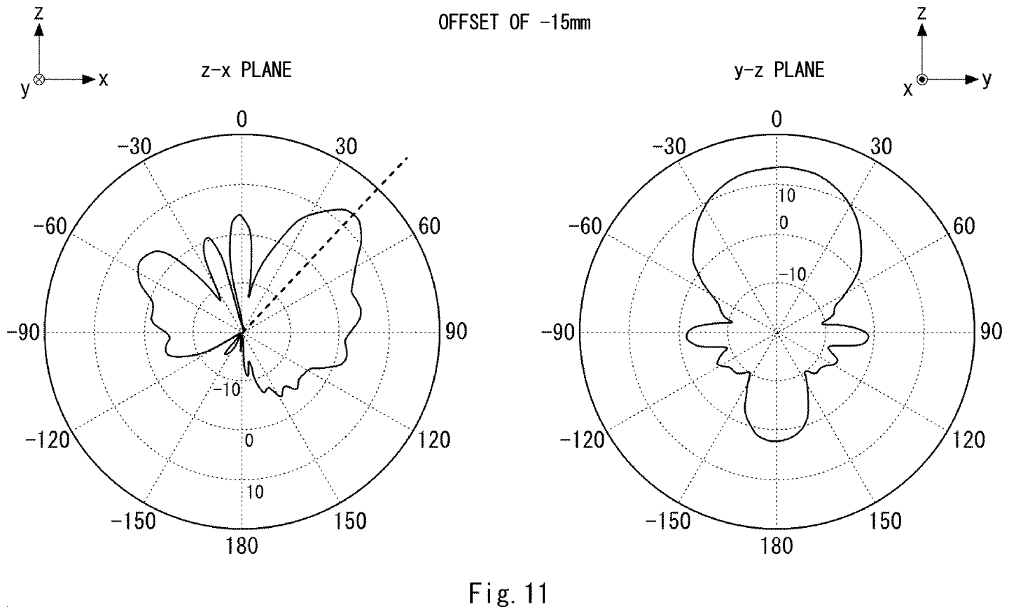

A relationship between the position of the radio wave source 2 and the radio wave emitted from the radio wave deflection element 1 will be described hereinafter. FIGS. 9, 10 and 11 show radio wave emission patterns when the offset of the radio wave source 2 is set to 0 mm, −7.5 mm, and −15 mm, respectively. In each of the diagrams showing emission patterns of radio waves described below, the radial direction of the chart indicates the strength [dBi] of the radio wave, and the circumferential direction thereof indicates the angle. Further, it is assumed that the angle increases in the direction from the z-axis toward the x-direction or the y-direction, i.e., increases in a clockwise direction. Further, the angle is 0° to 180° in the right semicircle and is 0° to −180° in the left semicircle.

In each of FIGS. 9 to 11, a point expressed as z=0 is the center of the radio wave deflection element. Further, the left side of the figure shows an emission pattern in the z-x plane, and the right side thereof shows an emission pattern in the y-z plane. As shown in FIGS. 9 to 11, it can be seen that as the offset amount of the radio wave source 2 increases, the deflection angle o of the radio wave in the emission pattern in the z-x plane increases. Therefore, it can be understood that the radio wave can be emitted at a desired deflection angle φ by setting the offset amount of the radio wave source 2 to a suitable value. In this example, the deflection angle φ is about 20° when the offset is −7.5 mm, and the deflection angle φis about 55° when the offset is −15 mm.

Next, the meaning of forming the radio wave deflection element 1 in a shape of which the width is limited to W, instead of forming as a disk-like planar Luneburg lens, will be described. The antenna 100 emits a radio wave in the direction of the deflection angle φ. Considering that the deflection angle φ is an elevation/depression angle and a radio wave is reliably emitted to the roadside base station BS, it is desired that the radio wave has an emission pattern that spreads to some extent in the direction of the azimuth angle θ (i.e., in the horizontal direction). Therefore, in this configuration, the radio wave deflection element 1 is formed as a planar Luneburg lens of which the width W is limited. Note that it is desired that the width W be an aperture width with which the diffraction effect of a radio wave can be efficiently used, and it is also desired that the width W be roughly equal to or smaller than the wavelength of the emitted radio wave. As can be seen from the emission patterns on the right sides in FIGS. 9 to 11, it is possible to widen the emission pattern in the direction of the azimuth angle θ by limiting the width of the radio wave deflection element 1 and thereby narrowing the aperture of the radio wave deflection element 1 in the width direction (i.e., in the y-direction).

Next, the function of the cavity cover 3 will be described. The cavity cover 3 is formed as a box-shaped member formed by a conductive member, for example, SUS 303. As a result, the cavity cover 3 prevents radio waves from leaking from the cavity 101 and also suppresses side lobes which would otherwise appear in the emission pattern of the radio wave emitted from the radio wave deflection element 1.

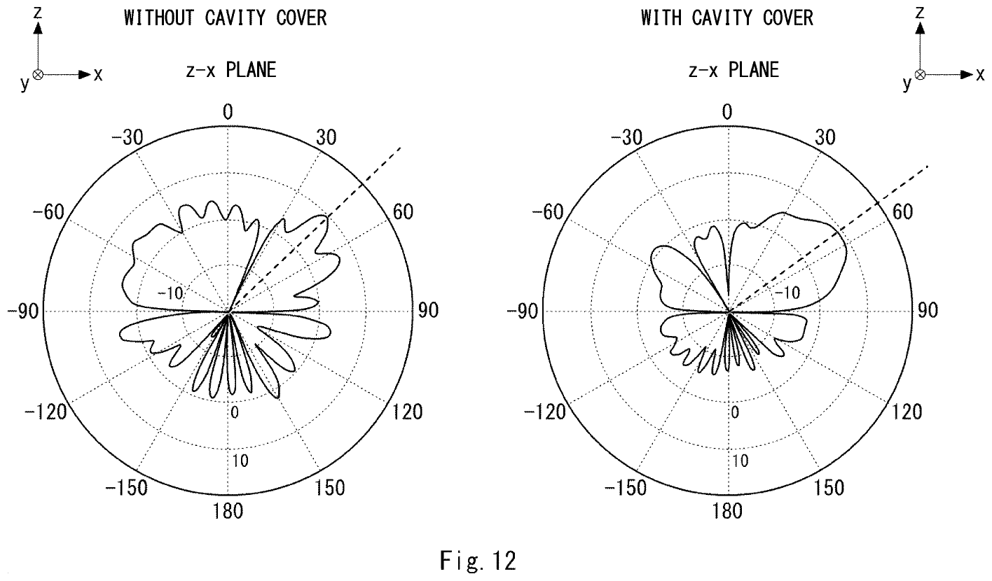

FIG. 12 shows a difference between an emission pattern of a radio wave when the cavity cover 3 is provided and that when no cavity cover 3 is provided. The left side in FIG. 12 shows an emission pattern in a comparative example in which no cavity cover 3 is provided, and the right side shows an emission pattern when the cavity cover 3 is provided. When no cavity cover 3 is provided, large side lobes are formed in a range between 0° and −90°, which is not the direction in which the radio wave should be emitted. In contrast, it can be understood that the side lobes in the range between 0° and −90° are significantly suppressed when the cavity cover 3 is provided. Therefore, it is possible to suppress the emission of a radio wave in an unintended direction by providing the cavity cover 3.

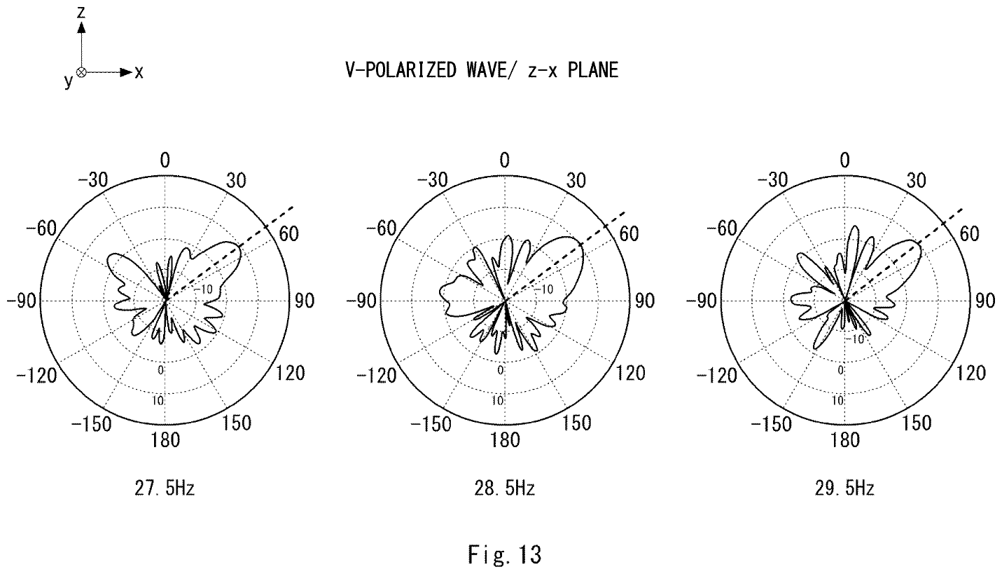

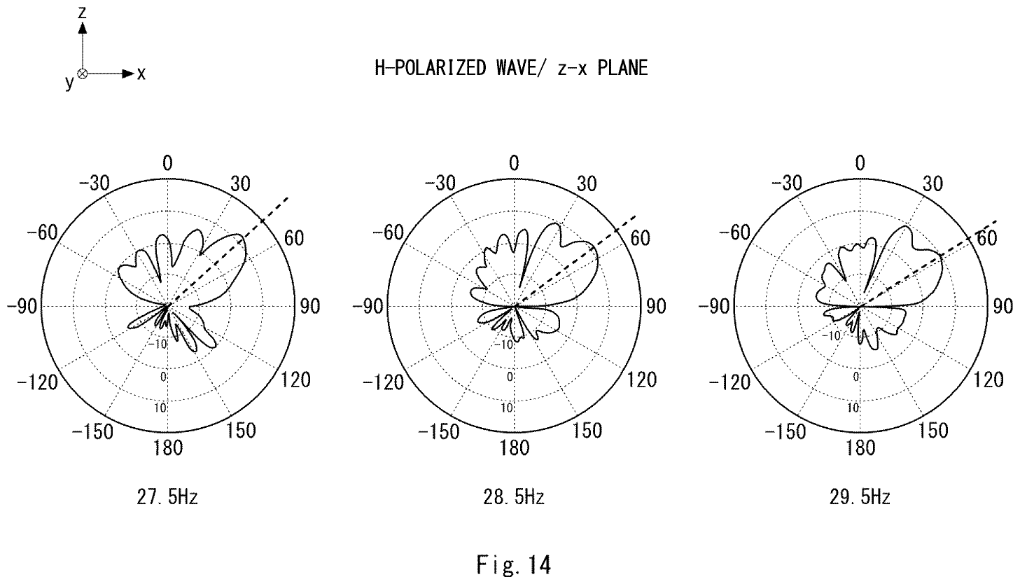

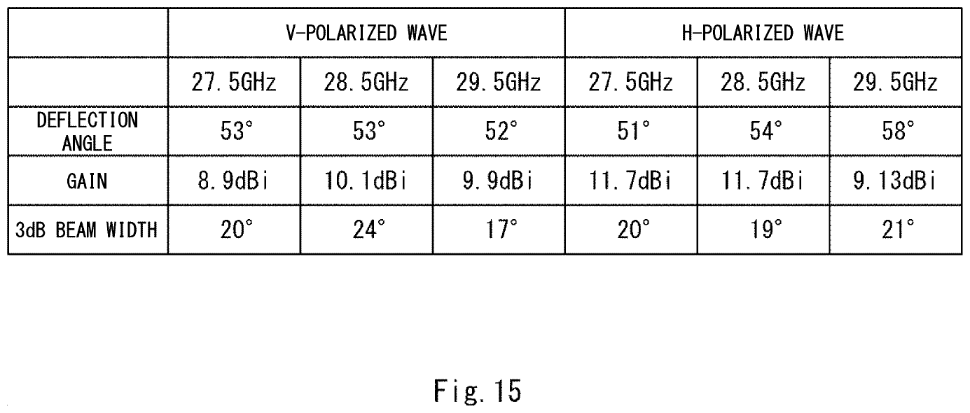

Next, an emission pattern when the radio wave emitted from the radio wave source 2 is an H-polarized wave or a V-polarized wave will be examined. FIG. 13 shows emission patterns of V-polarized waves when the antenna 100 is bonded to a windshield. FIG. 14 shows emission patterns of H-polarized waves when the antenna 100 is bonded to a windshield. FIG. 15 shows deflection angles, gains, and beam widths of the V-polarized waves shown in FIG. 13 and those of the H-polarized waves shown in FIG. 14. As can be seen from FIGS. 13 to 15, both V-polarized waves and H-polarized waves can be deflected at frequencies between 27.5 GHZ and 29.5 GHz in a similar manner.

Note that needless to say, even when the antenna 100 is bonded to a rear glass, both V-polarized waves and H-polarized waves can be deflected at frequencies between 27.5 GHz and 29.5 GHz in a similar manner.

Note that radio waves emitted from the antenna 100 have been described in the above descriptions. Since it is assumed that the antenna 100 is bonded to a glass surface, the influence of the glass on radio waves cannot be ignored. Therefore, the influence of the presence of a glass on a radio wave will be examined. Here, it is assumed that the windshield has a structure in which a PVB (Poly Vinyl Butyral) resin is sandwiched between two 2 mm thick soda glass sheets. It is assumed that: the dielectric constant of the soda glass is 6.91; the loss tangent thereof at 28 GHz is 0.018; the dielectric constant of the PVB resin is 2.66; and the loss tangent thereof at 28 GHz is 0.029.

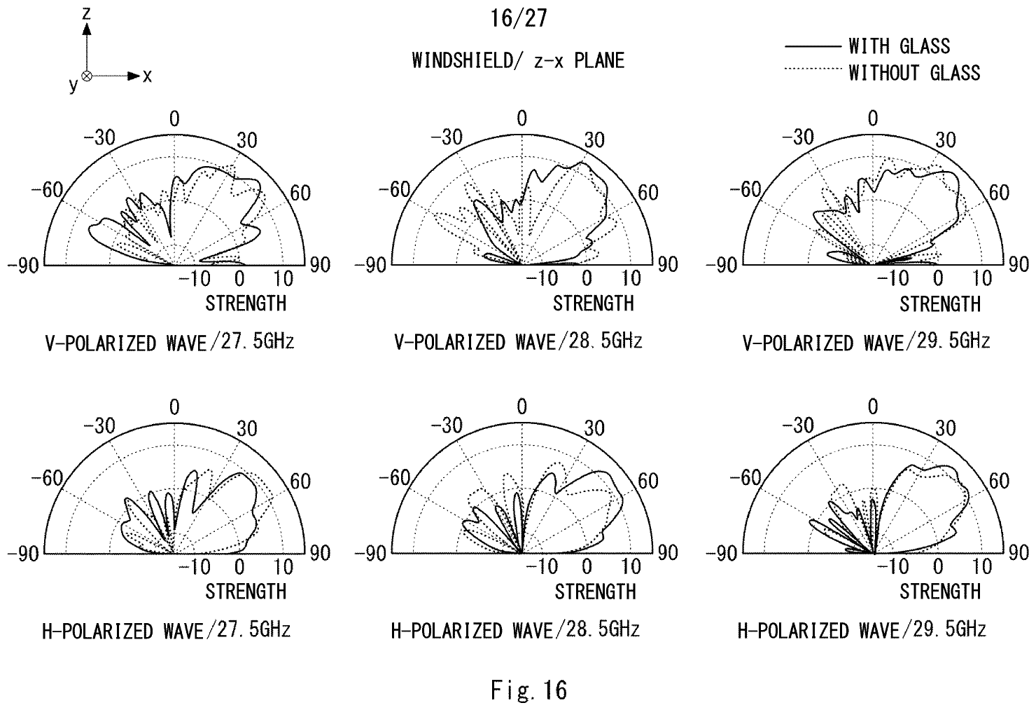

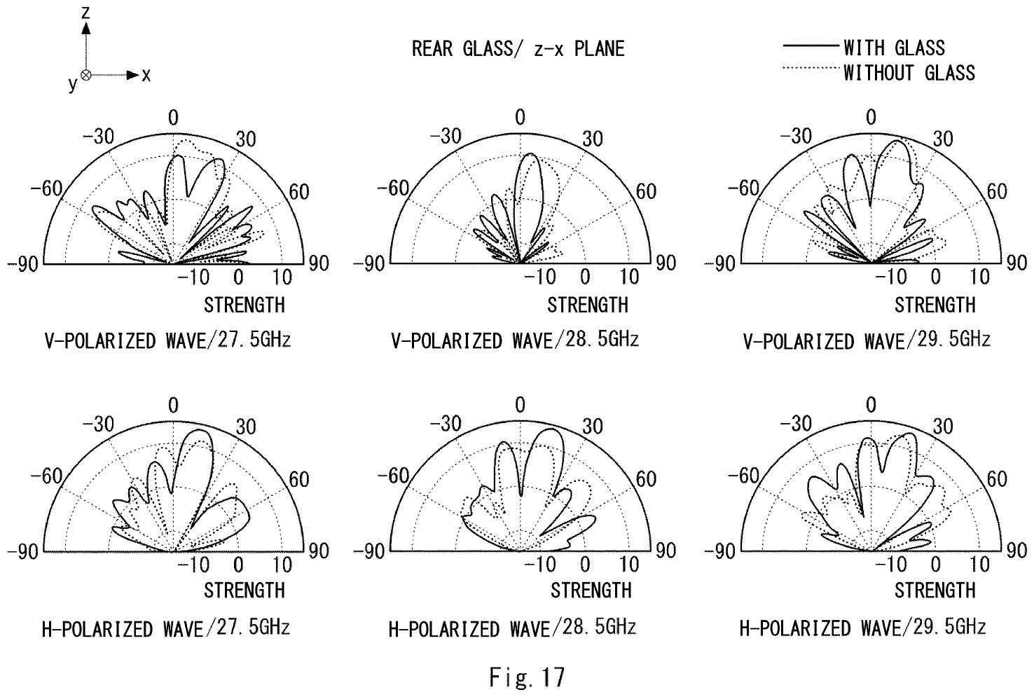

FIG. 16 shows emission patterns of V-polarized waves and H-polarized waves when the antenna 100 is bonded to a windshield. FIG. 17 shows emission patterns of V-polarized waves and H-polarized waves when the antenna 100 is bonded to a rear glass. As can be seen from FIGS. 16 and 17, although the emission patterns are somewhat affected by the presence or absence of the glass, the deflection angle and gain of the radio wave are roughly maintained, and the radio waves can be deflected in desired directions. That is, even when the antenna 100 is bonded to a glass, it is possible to emit a radio wave in a desired direction through the glass in a frequency range between 27.5 GHz and 29.5 GHz.

As described above, according to the above-described configuration, it is possible to provide a small antenna having a simple structure, capable of deflecting a radio wave emitted therefrom to a desired elevation angle and emitting a radio wave in a relatively wide emission pattern in the azimuthal direction.

### Second Embodiment

In the antenna 100 described in the first embodiment, the emitting direction of the radio wave is a fixed direction determined by the offset amount of the radio wave source 2 and the layer structure of the radio wave deflection element 1. However, considering that antennas are mounted on various apparatuses and that radio waves may be emitted to various positions at which the target objects are located, it is desirable that the emitting direction of a radio wave can be adjusted. Therefore, in this embodiment, an antenna capable of adjusting the emitting direction of a radio wave will be described.

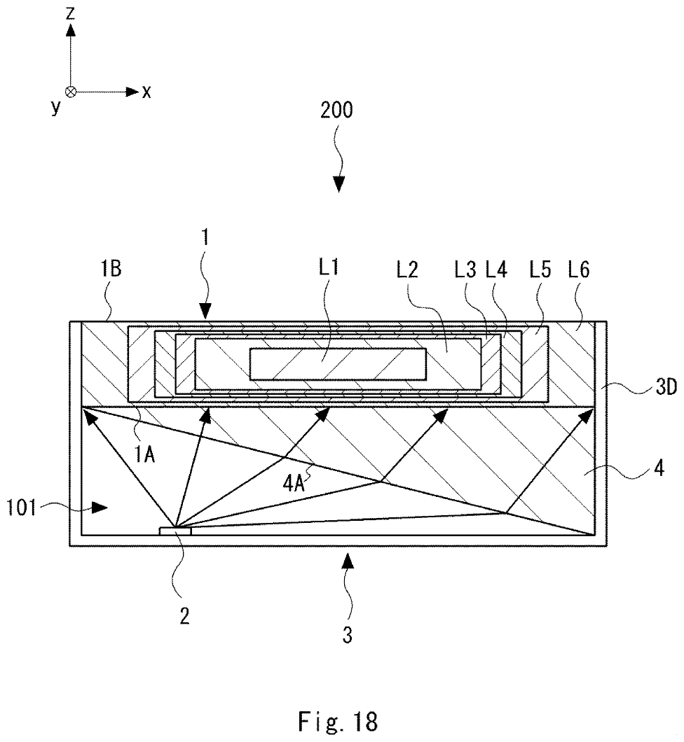

FIG. 18 is a cross-sectional diagram in the z-x plane of an antenna 200 according to the second embodiment. The antenna 200 has a configuration that is obtained by adding a prism 4 made of a dielectric to the antenna 100 according to the first embodiment. The prism 4 has a right-angled triangular shape on the z-x cross section, and its bottom surface is in surface contact with an incident plane 1A of a radio wave deflection element 1. Further, its thickness gradually increases from the −x side to the +x side. In this example, the prism 4 has a thickness of 11 mm in the z-direction and a width W of 10 mm (W=10 mm), which is equal to the width of the radio wave deflection element 1. The prism 4 can be made of any of various materials such as an ABS resin, and the dielectric constant of the prism 4 is 2.5.

By providing the prism 4, the radio wave emitted from the radio wave source 2 is refracted by an inclined surface 4A of the prism 4 and then is incident on the radio wave deflection element 1. Therefore, it is possible to adjust the incident angle of the radio wave on the incident plane 1A by adjusting the inclination angle of the inclined surface 4A relative to the incident plane 1A. As a result, it is possible to adjust the emitting angle of a radio wave emitted from the exit plane 1B of the radio wave deflection element 1.

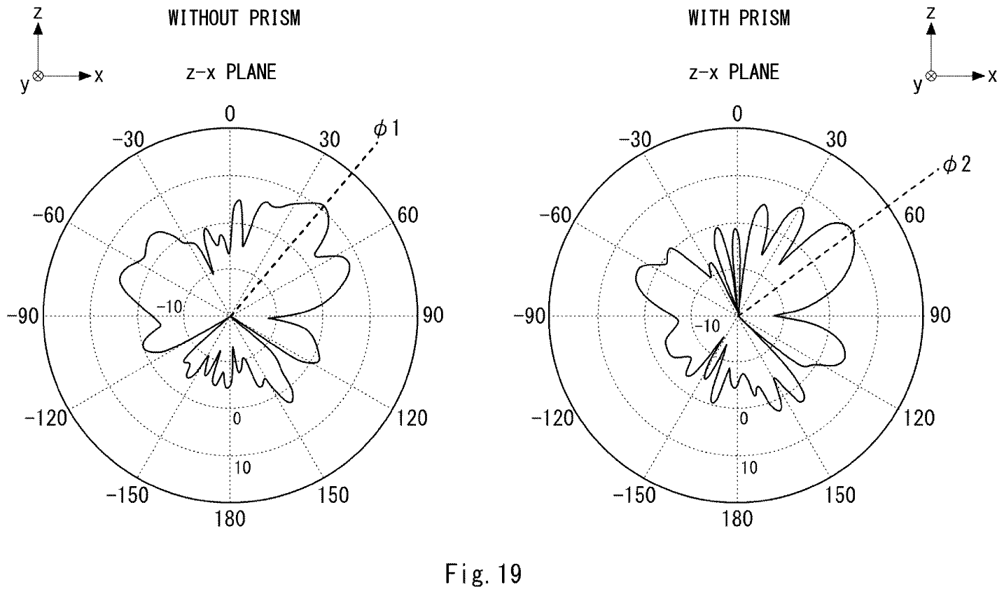

FIG. 19 shows a difference between an emission pattern when the prism 4 is provided and that when no prism 4 is provided. The left side in FIG. 19 shows an emission pattern in the z-x plane when no prism 4 is provided, and the right side shows an emission pattern when the prism 4 is provided. Note that in this example, the antenna is configured so that the emitting direction of a radio wave when no prism 4 is provided is about 40°. As can be seen from FIG. 19, the deflection angle φ1 of the radio wave when no prism 4 is provided is about 40°, while the deflection angle φ2 of the radio wave when the prism 4 is provided is about 55°. In this way, it is possible to adjust the deflection angle of a radio wave by inserting the prism 4 in the cavity 101.

Therefore, by providing the prism 4, it is possible to adjust the emitting angle of a radio wave emitted from the exit plane 1B of the radio wave deflection element 1 within a range in which the emitting angle can be adjusted by the shape of the prism 4 without changing either of the offset amount of the radio wave source 2 and the layer structure of the radio wave deflection element 1.

### Third Embodiment

In the first embodiment, the radio wave deflection element 1 has the layer structure shown in FIG. 7. However, this is merely an example, and the radio wave deflection element 1 can have a layer structure different from that shown in FIG. 7. In this embodiment, a method for designing a layer structure of a radio wave deflection element will be described.

The following description will be given on the assumption that a planar Luneburg lens is realized by compressing (i.e., reducing the size of) an ideal spherical Luneburg lens having a radius R like the one disclosed in Non-patent Literature 1 or 2 in the z-direction. Note that since the dielectric constant of an ideal spherical Luneburg lens changes in a continuous manner, the dielectric constant of the planar Luneburg lens, which is obtained by simply compressing an ideal spherical Luneburg lens in the z-direction, also changes in a continuous manner. When the compressibility of the z-coordinate of the planar Luneburg lens with respect to the z-coordinate of an ideal spherical Luneburg lens is represented by δ and the radius of the ideal spherical Luneburg lens is represented by R, the z-coordinate of the planar Luneburg lens is expressed by the below-shown Expression [1]. Note that in Expression [1], the z-coordinate of the ideal spherical Luneburg lens having a radius R is represented by Z_{c}. Further, since the planar Luneburg lens is not compressed in the x-direction, the x-coordinate of the planar Luneburg lens is the same as that of the ideal spherical Luneburg lens having the radius R.

$$\begin{matrix}[ Expression 1 ] & \\ z = \frac{δ}{\sqrt{{R}^{2} - {x}^{2}}} {z}_{C} & [ 1 ]\end{matrix}$$

In this case, the dielectric constant & of the planar Luneburg lens at a point (x, z) on the z-x cross section is expressed by the below-shown expression.

$$\begin{matrix}[ Expression 2 ] & \\ ε = ( 2 - \frac{( {R}^{2} - {x}^{2} ) {z}^{2} + {( δ x )}^{2}}{{( δ R )}^{2}} ) * \sqrt{{R}^{2} - {x}^{2}} / δ & [ 2 ]\end{matrix}$$

Here, in order to obtain the profile of the dielectric constant in a direction perpendicular to the principal surface of the planar Luneburg lens which passes through the center thereof, i.e., in the z-direction, when x is set to zero (x=0) in Expression [2], the dielectric constant ε_{z} in the z-direction of the lens material of which the planar Luneburg lens is made can be expressed by Expression [3].

$$\begin{matrix}[ Expression 3 ] & \\ {ε}_{z} = ( 2 - \frac{{z}^{2}}{{δ}^{2}} ) * \frac{R}{δ} & [ 3 ]\end{matrix}$$

When Expression [3] is solved for z, the below-shown Expression [4] is obtained.

$$\begin{matrix}[ Expression 4 ] & \\ z = δ \sqrt{2 - \frac{{ε}_{z} * δ}{R}} & [ 4 ]\end{matrix}$$

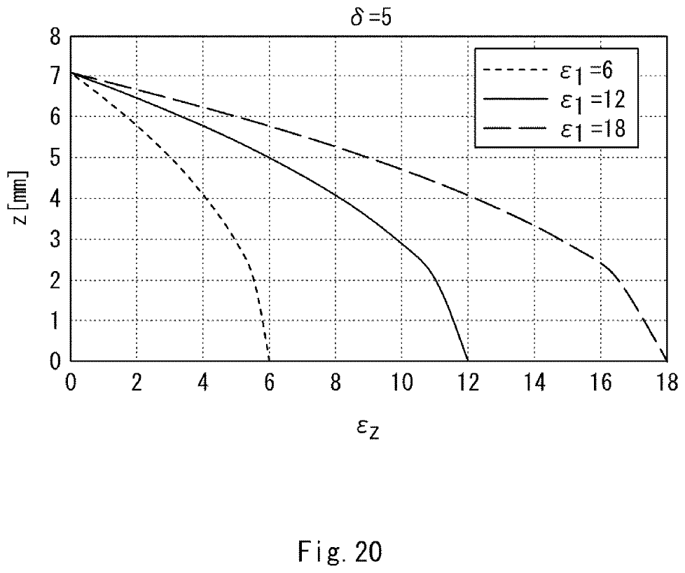

FIG. 20 shows a relationship between the z-coordinate in the axial direction of the planar Luneburg lens and the dielectric constant ε_{z} thereof, expressed by Expression [4]. Here, as an example, assume cases where: the compressibility δ is 5; six dielectric layers L1 to L6 are provided; and the maximum value εₘₐₓ of the dielectric constant of an ideal spherical Luneburg lens, i.e., the dielectric constant εᵢ of the innermost layer L1, is 6, 12 and 18, respectively. Note that it is assumed that the radius R of the ideal spherical Luneburg lens is 15 mm, 30 mm, and 45 mm, respectively, so that when z=0, i.e., at the center of the ideal spherical Luneburg lens, the maximum value εₘₐₓ of the dielectric constant becomes 6, 12 and 18, respectively.

In order to realize a planar Luneburg lens, as shown in FIG. 20, ideally, it is desirable that the dielectric constant ε_{z} change in a continuous manner with respect to the z-coordinate. However, it is difficult to manufacture a lens of which the dielectric constant ε_{z} changes in a continuous manner. Therefore, in this embodiment, a planar Luneburg lens is formed by discretizing the value of the dielectric constant from the center of the lens to the outer edge thereof, i.e., by introducing a multilayer structure having different dielectric constants.

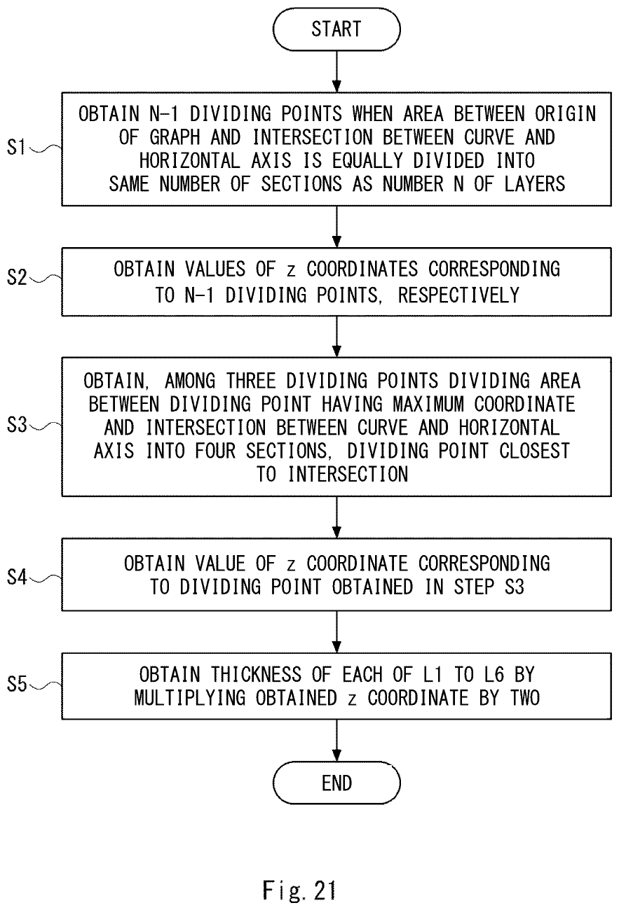

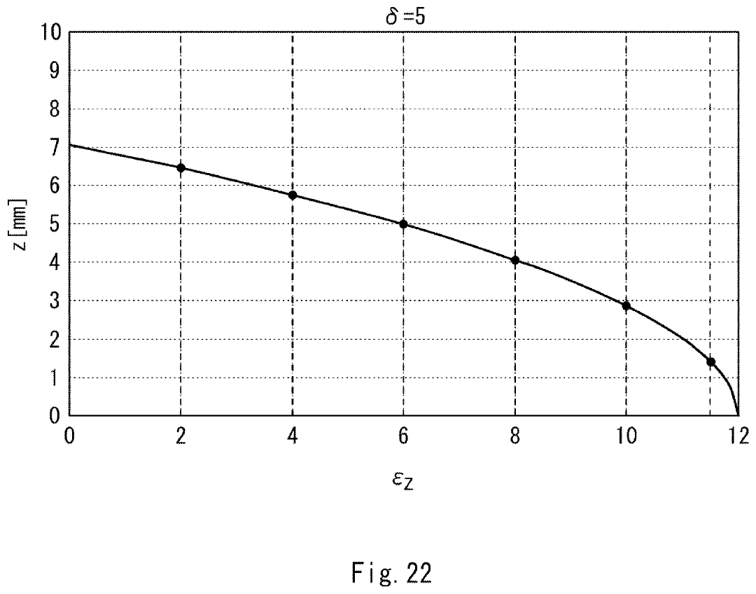

The dielectric constant and thickness of each of the dielectric layers L1 to L6 is determined according to a procedure which will be described hereinafter with reference to FIG. 20. FIG. 21 is a flowchart of a procedure for determining dielectric constants and thicknesses of a plurality of dielectric layers constituting a radio wave deflection element. FIG. 22 shows an overview of a design of dielectric constants and thicknesses of dielectric layers when the number of layers is six. The curve shown in the graph shown in FIG. 22 is the same as the curve shown in FIG. 20 in which the maximum value εₘₐₓ of the dielectric constant of the ideal spherical Luneburg lens is adjusted to 12 (and the radius R is set to 30 mm)

### Step S1

Firstly, the z-coordinates of the outer surfaces of the dielectric layers other than the innermost dielectric layer L1 (in the case of six layers, the dielectric layers L2 to L6) are determined. Specifically, the region between the origin in FIG. 20 and a point having the maximum dielectric constant εₘₐₓ, which is the intersection of the horizontal axis and the curve, is equally divided into the same number of regions as the number N of dielectric layers, so that N−1 points at the dielectric constants ε_{z} at the boundaries of the divided regions on the curve are obtained. The N−1 points on the curve are used to obtain the dielectric constants of the dielectric layers other than the innermost dielectric layer L1 in descending order of the dielectric constant ε_{z}. Here, it is assumed that the maximum dielectric constant εₘₐₓ is equal to 12 (εₘₐₓ=12) and the number N of layers is six (N=6). Then, the points on the curve at the values of the boundaries of the divided regions, i.e., at the values corresponding to ε_{z}=10, 8, 6, 4 and 2, are obtained, and these points are used to obtain the dielectric constants of the dielectric layers L2 to L6, respectively.

### Step S2

The values of the z-coordinates corresponding to the N−1 points, respectively, which have been obtained in the step S1, are obtained. In this example, the z-coordinates corresponding to ε_{z}=10, 8, 6, 4 and 2 are expressed as z=3.3, 5.25, 5.5, 6.2 and 6.9. The z-coordinates obtained here are determined as the z-coordinates of the outer surfaces of the dielectric layers L6 to L2, respectively. That is, the five points on the curve are expressed as (ε_{z}, z)=(10, 2.9), (8, 4.1), (6, 5), (4, 5.75) and (2, 6.45).

### Step S3

Next, the z-coordinate of the outer surface of the innermost dielectric layer L1 is determined. Note that the z-coordinate of the outer surface of the dielectric layer L1 is determined so as not to be too close to the z-coordinate of the outer surface of the outer dielectric layer L2 in consideration of the manufacturability of the dielectric layers. In this embodiment, among the points (quartile points) at which the region between the point related to the outer surface of the dielectric layer L2 (in this example, (ε_{z}, z)=(10, 2.9)) and the intersection of the curve and the horizontal axis into the four sections, the point closest to the intersection is obtained.

### Step S4

The value of the z-coordinate corresponding to the point obtained in the step S3 is obtained. In this example, z=1.65 is obtained as the z-coordinate of the point closest to the intersection among the three quartile points between the point (ε_{z}, z)=(10,2.9) related to the outer surface of the dielectric layer L2 and the intersection. The z-coordinate obtained here is the dividing point corresponding to the dielectric layer L1 having the maximum dielectric constant and is used as an index for determining the thickness of the dielectric layer L1.

Although the z-coordinate of the point closest to the intersection among the points at which the region between the point related to the outer surface of the dielectric layer L2 and the intersection of the curve and the horizontal axis into four sections (i.e., quartile points) is determined as the z-coordinate of the outer surface of the dielectric layer L1 in this example, it is merely an example. Other values may be used as appropriate as long as the value is not too close to the z-coordinate of the outer surface of the outer dielectric layer L2. For example, the z-coordinate of an arbitrary point on the curve between the point related to the outer surface of the dielectric layer L2 and the intersection of the curve and the horizontal axis may be determined as the z-coordinate of the outer surface of the dielectric layer L1 as long as the dielectric layers L1 and L2 are not excessively thin in consideration of the manufacturability and as long as the characteristics as an antenna are not significantly affected. As an example, the z-coordinate of a point that is sifted by 40 to 50% with respect to the z-coordinate of the point closest to the intersection among the aforementioned quartile points may be used as the z-coordinate of the outer surface of the dielectric layer L1.

### Step S5

Since the six z-coordinates obtained in the steps S2 and S4 are the z-coordinates of the outer boundary surfaces of the dielectric layers L1 to L6, respectively, the thicknesses T_{z1} to T_{z6} of the dielectric layers L1 to L6 in the z-direction can be obtained by multiplying the obtained z-coordinates by two. In this example, they are expressed as (T_{z1}, T_{z2}, T_{z3}, T_{z4}, T_{z5}, T_{z6})=(3.3, 5.8, 8.2, 10, 11.5, 12.9).

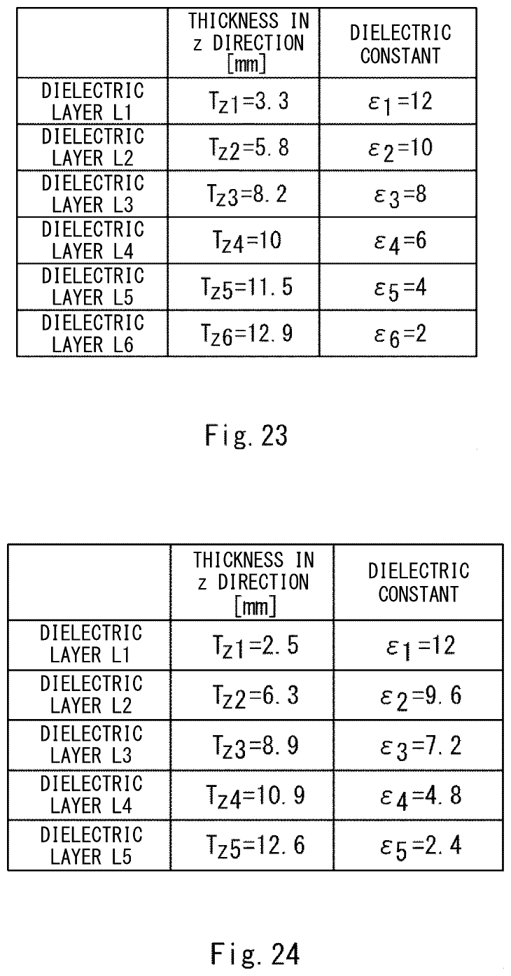

As described above, according to the above-described procedure, it is possible determine the dielectric constant and thickness of each of a plurality of dielectric layers constituting the planar Luneburg lens. FIG. 23 shows the dielectric constants and thicknesses in the z-direction of the dielectric layers L1 to L6 obtained from the curve shown in the graph shown in FIG. 22.

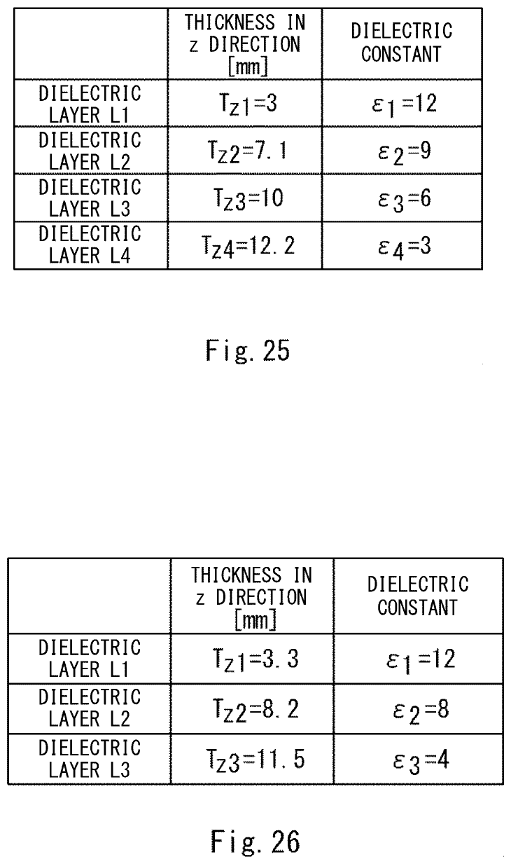

For each of a plurality of lenses including different numbers of dielectric layers, the dielectric constants and thicknesses of the dielectric layers determined through the steps S1 to S5 will be examined hereinafter. FIGS. 24 to 26 show examples of the dielectric constants and thicknesses of dielectric layers of a plurality of lenses of which the numbers of layers are 5, 4 and 3 (N=5, 4 and 3), respectively, determined through the steps S1 to S5. As shown in the tables, even when the number of layers is changed as desired, the layer structure of the radio wave deflection element can be determined through the above-described procedure.

As described above, when a planar Luneburg lens is realized by compressing, i.e., reducing, the thickness of an ideal spherical

Luneburg lens, its length in the horizontal direction (x-direction), i.e., the dielectric constant profile of the dielectric material, is also affected. Therefore, next, the determination of the length of each dielectric layer in the x-direction will be described. In this embodiment, since the lens is not compressed in the x-direction, the profile of the dielectric constant in the x-direction, which passes through the center of the ideal spherical Luneburg lens, is applied to the lens. In this case, the dielectric constant εₓ in the x-direction is expressed by the below-shown Expression [5]:

$$\begin{matrix}[ Expression 5 ] & \\ {ε}_{x} = ( 2 - \frac{{x}^{2}}{{R}^{2}} ) & [ 5 ]\end{matrix}$$

By solving Expression [5] for x, the below-shown Expression [6] is obtained.

$$\begin{matrix}[ Expression 6 ] & \\ x = R \sqrt{2 - {ε}_{x}} & [ 6 ]\end{matrix}$$

However, in Expression [6], the maximum value of the dielectric constant εₓ in the x-direction is limited to 2. Therefore, Expression [6] is modified to the below-shown Expression [7] in order to adapt it to a dielectric constant profile in the z-direction using larger dielectric constants.

$$\begin{matrix}[ Expression 7 ] & \\ x = R \sqrt{2 - \frac{{ε}_{x}}{{ε}_{max} / 2}} + 2 δ & [ 7 ]\end{matrix}$$

The first term on the right side of Expression [7] is changed because both sides of Expression [5] are multiplied by εₘₐₓ/2 so that the maximum value of the dielectric constant becomes the dielectric constant εₘₐₓ. Further, 2δ in the second term on the right side is a constant that is added as the lens is made flat.

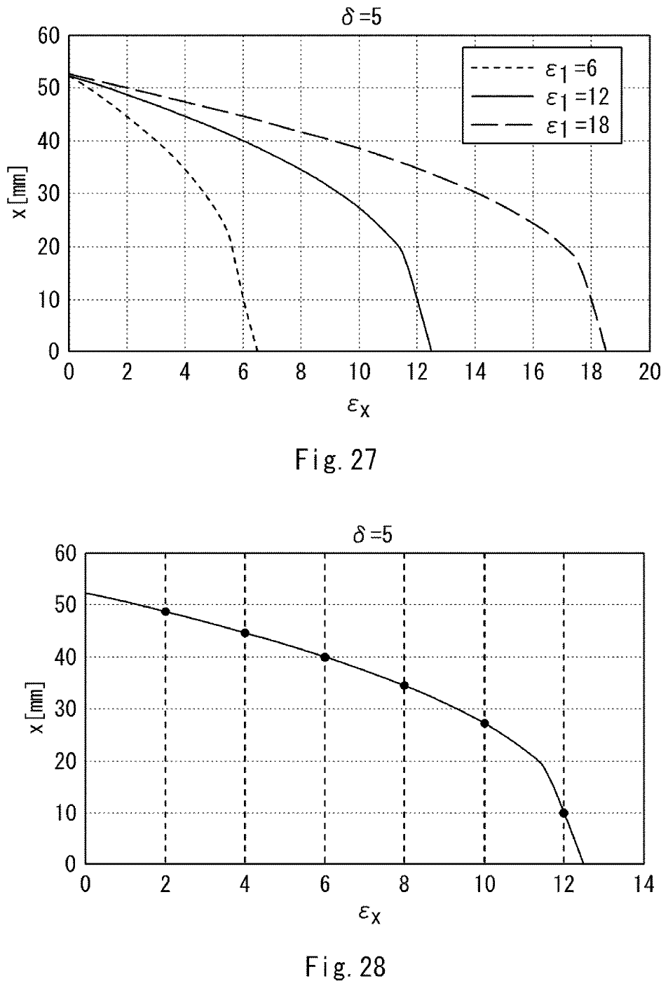

FIG. 27 shows a relationship between the x-coordinate of the planar Luneburg lens and the dielectric constant εₓ, expressed by Expression [7]. Note that as in the case of the z-direction, it is assumed that the compressibility δ is 5 and six dielectric layers L1 to L6 are provided, so that cases where the maximum values εₘₐₓ of the dielectric constants, i.e., the dielectric constants ε₁ of the innermost layers L1 are 6, 12 and 18, respectively, are shown.

As for the width in the x-direction, the dielectric constants and thicknesses of the dielectric layers L1 to L6 can be determined through the above-described procedure including the steps S1 to S5 by using FIG. 27. FIG. 28 shows an overview of a design of dielectric constants and widths in the x-direction of dielectric layers when the number of dielectric layers is six. The curve shown in the graph shown in FIG. 28 is the same as the curve shown in FIG. 27 in which the number of layers is six.

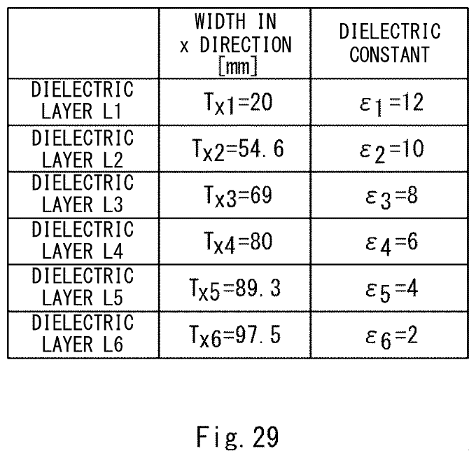

Since the x-coordinates obtained from FIG. 28 are the x-coordinates of the outer boundary surfaces of the dielectric layers L1 to L6, respectively, the widths Tₓ₁ to Tₓ₆ of the dielectric layers L1 to L6 in the x-direction can be obtained by multiplying the obtained x-coordinates by two. FIG. 29 shows dielectric constants and widths in the x-direction of the dielectric layers L1 to L6 obtained from the curve shown in the graph shown in FIG. 28. In this example, they are expressed as (T_{z1}, T_{z2}, T_{z3}, T_{z4}, T_{z5}, T_{z6})=(20, 54.6, 69, 80, 89.3, 97.5).

Further, as in the case of the thickness in the z-direction, needless to say, even when the number of dielectric layers is changed, the widths in the x-direction can be determined as appropriate through the above-described procedure.

Note that although cases where six dielectric layers are provided have been described above, the number of dielectric layers may be any number equal to or larger than two. However, it is preferred that the number of dielectric layers be equal to or smaller than about 10 because the more the number of layers is increased, the more difficult it becomes to manufacture a radio wave deflection element, and the less significant the meaning of discretizing the dielectric constant becomes.

### Other Embodiments

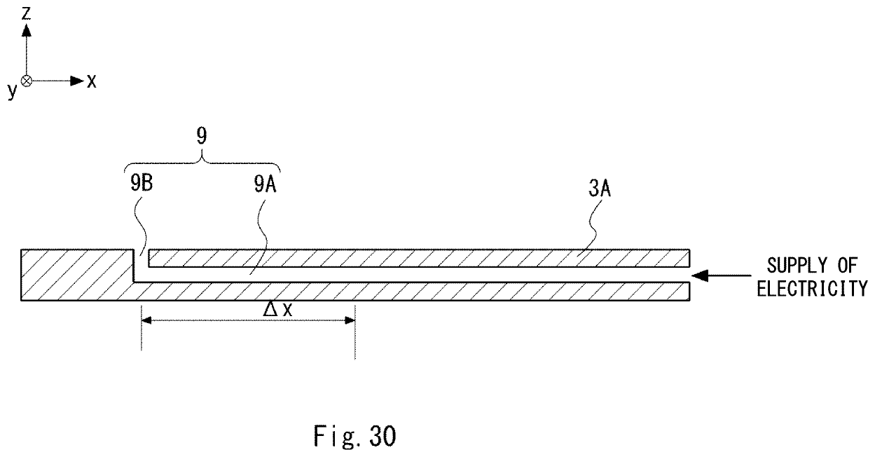

Note that the present invention is not limited to the above-described embodiments, and they may be modified as appropriate without departing from the scope and spirit of the invention. For example, although the above-described embodiments have been described on the assumption that the radio wave source is formed as a patch antenna, this is merely an example. The radio wave source may be formed, for example, as a waveguide. FIG. 30 schematically shows a cross-sectional configuration of a radio wave source formed as a waveguide. A radio wave source 9 shown in FIG. 30 is composed of a waveguide 9A extending in the x-direction and a waveguide 9B disposed at a position offset from the center of a bottom plate member 3 A of a cavity cover 3 by a predetermined distance and extending from the waveguide 9A in the +z-direction, both of which are provided in the bottom plate member 3A. In this case, as shown in FIG. 30, a feeding port of the waveguide 9A can be provided on a side surface (y-z plane) of the bottom plate member 3A.

In this case, it is possible to prevent, by the above-described configuration, the feeding means of the radio wave source 2 from protruding from the antenna 100 in the −z-direction, i.e., in the direction perpendicular to the glass surface, which would otherwise protrude therefrom when the above-described configuration is not adopted. That is, since the waveguide 9A and the feeding means (e.g., a feeding waveguide) for supplying electricity to the waveguide 9A can be arranged along the x-direction, it is possible to prevent the feeding means from protruding in the −z-direction and to lay out the feeding means on the glass surface. In this way, the antenna 100 can be mounted on a glass surface in a more compact manner.

Note that although the above description has been given on the assumption that the waveguide 9A extends in the x-direction, the waveguide 9A may extend in the y-direction. In this case, the waveguide 9A and the feeding means (e.g., a feeding waveguide) for supplying electricity to the waveguide 9A can be arranged along the y-direction. Even in this case, it is possible to prevent the feeding means from protruding in the −z-direction and to lay out the feeding means on the glass surface.

What is claimed is:

1. An antenna comprising:
a radio wave deflection element formed as a plate-like member including a plurality of stacked layers, having a principal surface perpendicular to a first direction, and having a longitudinal direction in a second direction perpendicular to the first direction; and
a radio wave source disposed so as to be separated from the radio wave deflection element in the first direction and offset from a center of the radio wave deflection element by a predetermined distance in the first direction, and configured to emit a radio wave to the radio wave deflection element, wherein
dielectric constants of the plurality of dielectric layers decrease in a stepwise manner as a distance from the center of the radio wave deflection element increases in the first direction.

2. The antenna according to claim 1, wherein the plurality of dielectric layers are arranged in a nested manner from the center of the radio wave deflection element.

3. The antenna according to claim 1, wherein the plurality of dielectric layers are formed by stacking flat dielectric layers in the first direction.

4. The antenna according to claim 1, wherein a length of the radio wave deflection element in a direction perpendicular to the first and second directions is substantially equal to or shorter than a wavelength of the radio wave.

5. The antenna according to claim 1, further comprising a cavity cover made of conductive material and configured to cover a surface of the radio wave deflection element facing in a direction perpendicular to the first direction and a cavity, the cavity being a space between the radio wave deflection element and the radio wave source.

6. The antenna according to claim 5, wherein
the cavity cover is formed as a box-shaped member with an opening formed on a side thereof on which the radio wave deflection element is held, and
the radio wave source is provided on an inner surface of a bottom plate of the box-shaped member opposed to the opening.

7. The antenna according to claim 6, further comprising a prism made of dielectric and disposed so as to be in contact with the radio wave deflection element in the cavity, wherein a thickness of the prism gradually increases from a position at which the radio wave source is disposed in a receding direction from the center of the radio wave deflection element through the center thereof.

8. The antenna according to claim 1, wherein the radio wave deflection element is formed as a planar Luneburg lens, the planar Luneburg lens being obtained by compressing an ideal spherical Luneburg lens in the first direction.

9. The antenna according to claim 8, wherein the radio wave deflection element is formed by cutting out a part of the planar Luneburg lens so as to have a predetermined width in a direction perpendicular to the first and second directions.

10. The antenna according to claim 8, wherein
when a radius of the ideal spherical Luneburg lens is represented by R; compressibility of the radio wave deflection element to the ideal spherical Luneburg lens is represented by δ; a coordinate in the receding direction from the center of the radio wave deflection element in the first direction is represented by z; a dielectric constant of dielectric material of which the radio wave deflection element is made at a z-coordinate is represented by ε_{z}; and a wavelength of a radio wave emitted from the radio wave source is 28.5 GHz±1.0 GHz, a below-shown expression holds for the z-coordinate:
$$\begin{matrix}[ Expression 1 ] & \\ z = δ \sqrt{2 - \frac{{ε}_{z} * δ}{R}} , & [ 1 ]\end{matrix}$$
and
dielectric constants of the plurality of dielectric layers in the first direction are defined by points discretely set on a curve represented by Expression [1].

11. The antenna according to claim 10, wherein
based on Expression [1], when in a graph of which a vertical axis indicates z-coordinates and a horizontal axis indicates dielectric constants εₓ at z-coordinates of the dielectric material, the number of dielectric layers stacked in the receding direction from the center of the radio wave deflection element in the first direction is represented by N,
a dielectric constant and a length in the first direction of each of N dielectric layers are determined so that:
in the horizontal axis, z-coordinates of N−1 points at which a region between an origin of the graph and an intersection of the curve and the horizontal axis is divided into N sections respectively become coordinates of boundaries of second to N-th dielectric layers as viewed from the center of the radio wave deflection element, the boundary of each dielectric layer being on a side thereof far from the center of the radio wave deflection element; and
a z-coordinate of a point included in a predetermined range including, among z-coordinates of three points corresponding to coordinates on the horizontal axis at which a region between a point having a minimum z-coordinate among the N−1 points and the intersection of the curve and the horizontal axis is divided into four sections, a point having a minimum z-coordinate becomes a z-coordinate of a boundary between a first dielectric layer and a second dielectric layer as viewed from the center of the radio wave deflection element.

12. The antenna according to claim 11, wherein
when a maximum value of a dielectric constant is represented by εₘₐₓ; a coordinate in a receding direction from the center of the radio wave deflection element in the second direction is represented by x;
and a dielectric constant of an x-coordinate of dielectric material of which the radio wave deflection element is made is represented by εₓ, a below-shown Expression holds for the x-coordinate:
$$\begin{matrix}[ Expression 2 ] & \\ x = R \sqrt{2 - \frac{{ε}_{x}}{{ε}_{max} / 2}} + 2 δ , & [ 2 ]\end{matrix}$$
and
dielectric constants of the plurality of dielectric layers in the second direction are defined by points discretely set on a curve represented by Expression [2].

13. The antenna according to claim 12, wherein
based on Expression [2], in a graph of which a vertical axis indicates x-coordinates and a horizontal axis indicates dielectric constants εₓ at x-coordinates of the dielectric material,
a dielectric constant and a length in the second direction of each of N dielectric layers are determined so that:
in the horizontal axis, x-coordinates of N−1 points at which a region between an origin of the graph and an intersection of the curve and the horizontal axis is divided into N sections respectively become coordinates of boundaries of second to N-th dielectric layers as viewed from the center of the radio wave deflection element, the boundary of each dielectric layer being on a side thereof far from the center of the radio wave deflection element; and
a x-coordinate of a point included in a predetermined range including, among x-coordinates of three points corresponding to coordinates on the horizontal axis at which a region between a point having a minimum x-coordinate among the N−1 points and the intersection of the curve and the horizontal axis is divided into four sections, a point having a minimum x-coordinate becomes a x-coordinate of a boundary between a first dielectric layer and a second dielectric layer as viewed from the center of the radio wave deflection element.

14. The antenna according to claim 13, wherein
in Expression [1], when 8=5; a maximum value εₘₐₓ of dielectric constants is 12; a radius R of an ideal spherical Luneburg lens is 30 mm; and the number N of layers is six,
a length of the first dielectric layer in the first direction is 3.3 mm; a length thereof in the second direction is 20 mm; and a dielectric constant thereof is 12,
a length of the second dielectric layer in the first direction is 5.8 mm; a length thereof in the second direction is 54.6 mm; and a dielectric constant thereof is 10,
a length of the third dielectric layer in the first direction is 8.2 mm; a length thereof in the second direction is 69 mm; and a dielectric constant thereof is 8,
a length of the fourth dielectric layer in the first direction is 10 mm; a length thereof in the second direction is 80 mm; and a dielectric constant thereof is 6,
a length of the fifth dielectric layer in the first direction is 11.5 mm; a length thereof in the second direction is 89.3 mm; and a dielectric constant thereof is 4, and
a length of the sixth dielectric layer in the first direction is 12.9 mm; a length thereof in the second direction is 97.5 mm; and a dielectric constant thereof is 2.
